(19) United States
(12) Patent Application Publication
(10) Pub. No.: US 2009/0086045 A1
(43) Pub. Date: Apr. 2, 2009

(54) Method and System for a Configurable Communications Interface

(76) Inventors: James Giebel, Centerport, NY (US); William Sackett, Rocky Point, NY (US)

Correspondence Address: MOTOROLA, INC., 1303 EAST ALGONQUIN ROAD, IL01/3RD, SCHAUMBURG, IL, 60196, US

(21) Appl. No.: 11/864,464

(22) Filed: Sep. 28, 2007

(51) Int. Cl. H04N 5/228

(52) U.S. Cl. 348/222.1; 348/E05.031

(57) ABSTRACT

An electronic device includes an imaging sensor collecting an image and creating an imaging signal corresponding to the image, an integrated circuit receiving the imaging signal from the imaging sensor and modifying a transfer characteristic of the imaging signal and a connector receiving the imaging signal from the integrated circuit having the modified transfer characteristic.

### FIELD OF INVENTION

The present application generally relates to systems and methods for configuring a communications interface for an imaging device. Specifically, the system and methods may manage input and output signals from an image device, such as a two-dimensional imager, in order to reduce electromagnetic interference emissions.

### BACKGROUND

The emission of electromagnetic interference (“EMI”), also called radio frequency interference (“RFI”), may be defined as a naturally occurring disturbance (or “electrical noise”) caused by one or more electrical components, such as an electrical circuit, due to electromagnetic radiation emitted from an external source of that component. The disturbance may interrupt, obstruct, or otherwise degrade the operation of the electrical circuit, as well as interfere with the performance of other nearby electrical equipment. Therefore, EMI may cause two or more electrical devices to interfere with each other, thereby affecting their performance and operation.

EMI is subjected to strict regulations by regulatory bodies, such as the Federal Communication Commission (“FCC”). Due to the potential interference with communication devices, the FCC has established limits of EMI emissions for electronic devices and mandate electromagnetic compatibility in order to prevent interference between multiple electronic devices, in addition to prevent any damage to the human body. Specifically, electrical equipment may be required to continue to function correctly when subjected to certain amounts of EMI. Likewise, the compliant electrical equipment should not emit EMI that might interfere with other electrical equipment, such as radios and other communication devices. Conventional methods such as component filters and/or electromagnetic enclosure shields may be used to control and reduce the effects of disruptive EMI, but these methods are expensive and consume a large amount of space on a printed circuit board (PCB) adding to both the expense and the size of the device.

### SUMMARY OF THE INVENTION

The present invention relates to an electronic device having an imaging sensor collecting an image and creating an imaging signal corresponding to the image, an integrated circuit receiving the imaging signal from the imaging sensor and modifying a transfer characteristic of the imaging signal and a connector receiving the imaging signal from the integrated circuit having the modified transfer characteristic.

The present invention also relates to a method for receiving an imaging signal. The method may include the following step: modifying a transfer characteristic of the imaging signal, the modification of the transfer characteristic reducing EMI emissions of the imaging signal and outputting the imaging signal with the modified transfer characteristic.

The present invention may further relates to a circuit having an input receiving a signal, a core performing at least one operation on the signal and an output modifying a transfer characteristic of the signal and outputting the signal having the modified transfer characteristic.

### BRIEF DESCRIPTION OF THE DRAWINGS

FIG. 1A shows an exemplary system for configuring a communications interface to manage the EMI emissions of an electronic device, such as an imaging device, according to exemplary embodiments of the present invention.

FIG. 1B shows an exemplary application-specific integrated circuit (“ASIC”) chip for controlling output signals according to the exemplary embodiments of the present invention.

FIG. 2 shows an exemplary schematic for a programmable current source within the exemplary ASIC chip according to the exemplary embodiments of the present invention.

FIG. 3 shows an exemplary schematic for a programmable output resistance within the exemplary ASIC chip according to the exemplary embodiments of the present invention.

FIG. 4 shows an exemplary schematic for a programmable delay within the exemplary ASIC chip according to the exemplary embodiments of the present invention.

### DETAILED DESCRIPTION

The present invention may be further understood with reference to the following description of exemplary embodiments and the related appended drawings, wherein like elements are provided with the same reference numerals. The exemplary embodiments of the present invention are related to systems and methods used for configuring a communications interface for an imaging device. Specifically, the exemplary embodiments provide systems and methods to manage input and output signals from an image device, such as a two-dimensional (“2D”) imager, in order to reduce electromagnetic interference emissions.

Those skilled in the art will understand that the exemplary embodiments of the present invention are described with reference to a 2D imaging sensor, but that the present invention may also be implemented in conjunction with other types of imaging sensors. In addition, the present invention is not limited to use with imaging sensors. That is, the exemplary embodiments of the present invention may also be applied to other types of components that transfer data within an electronic device in order to reduce the EMI emissions of these data transfers.

An electronic device such as a mobile computer, a personal digital assistant (“PDA”), mobile phone, personal communication device, bar code scanner, RFID reader, etc., may include a variety of electronic components including an imaging sensor. The imaging sensor may be used by the device to collect image data. As the imaging sensor collects image data, it may need to transfer this image data to other components of the electronic device such as a microcontroller, a microprocessor, a memory, etc. The transfer of this image data through the device may be via, for example, a flexible circuit board or a flexible connector (collectively referred to herein as “flex circuit(s)”). Those skilled in the art will understand that other types of circuits and/or connectors may also be used to transfer the image data within the electronic device, but that for space reasons it is more common for flex circuits to be used. The transfer of the image data may produce radiated emission problems. Specifically, data transferred from the device within a parallel interface may create a EMI emissions problem. Therefore, the exemplary embodiments of the present invention provide an option to manage the input and output signals throughout the device. Thus, the exemplary embodiments may reduce the radiated emissions, thereby eliminating the need to shield the flex circuits within the device. While the exemplary embodiments of the present invention describe an imaging sensor in communication with a flex circuit, it should be noted that the present invention may be applicable to any type of electronic component in communication with a circuit board or a conductor.

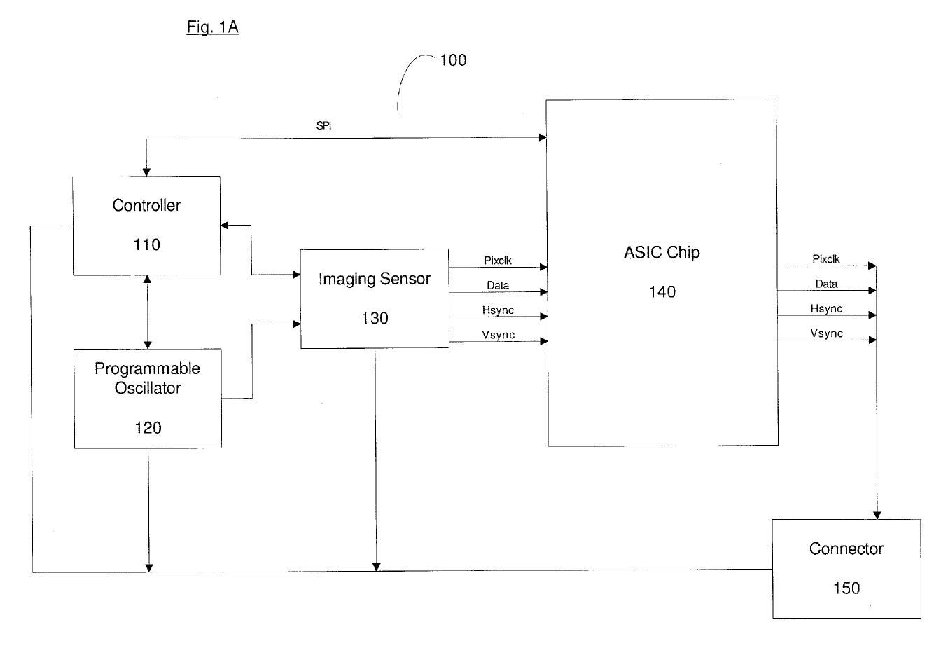

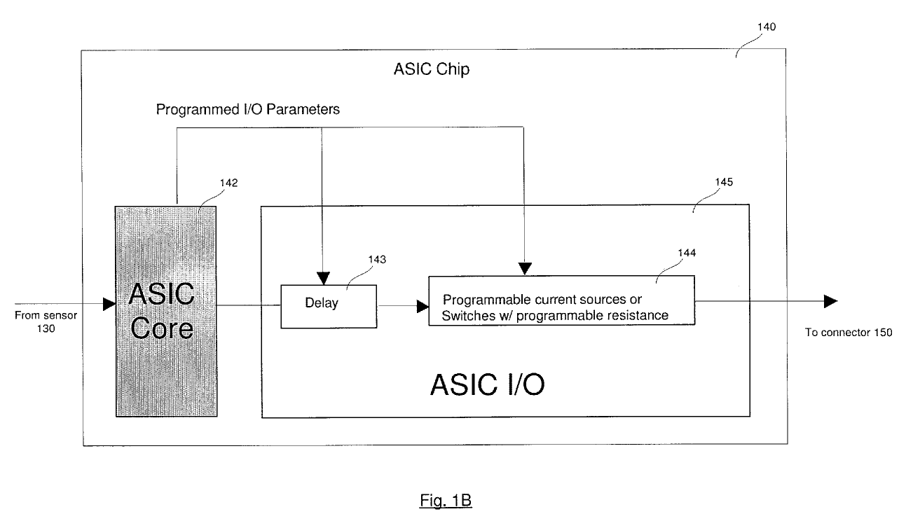

FIG. 1A shows an exemplary system 100 for configuring a communications interface to manage the EMI emissions of an electronic device, such as an imaging device, according to the exemplary embodiments of the present invention. According to the exemplary embodiment, FIG. 1A shows a block diagram view of the system 100, wherein the system 100 includes a controller 110, a programmable oscillator 120, an imaging sensor 130 (e.g., a 2D image sensor), an application-specific integrated (“ASIC”) chip 140, and a flex circuit connector 150. The imaging sensor 130 may be used to convert visual light images into electrical signals. The imaging sensor 130 may be in communication with the microprocessor 110 and the programmable oscillator 120. In addition, the output signal (e.g., the imaging signals) may be transmitted to the ASIC chip 140. Accordingly, the ASIC chip 140 may be utilized to process the input/output (“I/O”) signals received from the imaging sensor 130, and then transmit this data to the flex circuit connector 150 for further transfer of the image data. Furthermore, the ASIC chip 140 may be in communication with the controller 110 via a serial peripheral interface (“SPI”) connection.

The controller 110 may regulate the operation of the imaging sensor 130 by facilitating communications between the various components of the exemplary system 100. For example, the controller 110 may include a microcontroller, a microprocessor, an embedded controller, a further application-specific integrated circuit, a programmable logic array, a state machine, etc. The controller 110 may also be included as part of the ASIC chip 140. However, in the exemplary schematic of FIG. 1A, the controller 110 is shown as a separate component. The controller 110 may perform data processing, execute instructions and direct a flow of data between devices coupled to the controller 110 (e.g., the programmable oscillator 120, the imaging sensor 130, the ASIC chip 140, etc.). As will be explained below, the exemplary controller 110 may be used to program and configure various parameters of the ASIC chip 140, such as output current, output resistance, output signal delays, etc. These configured parameters may be set at a factory level during the manufacture of the electronic device. Furthermore, the configuration may be aligned on a product family basis. Therefore, the exemplary embodiments of the present invention may eliminate the need for end-user calibrations made to the controller 110. However, the exemplary embodiments may provide the end-user with the ability to re-program the ASIC chip 140, if desired.

The programmable oscillator 120 may be a spread spectrum clock oscillator having an intentionally modulated output frequency, wherein the programming of the oscillator 120 may be performed by the controller 110. The programmable oscillator 120 may be contained within a further ASIC chip (not shown) of the system 100. Furthermore, the programmable oscillator 120 may include a fundamental mode crystal controlled oscillator and a programmable integrated circuit for controlling the operating characteristics (e.g., output frequency, modulation frequency, output frequency spread spectrum percentage, etc.) of the oscillator 120. Within the programmable oscillator 120 may reside a phase-locked loop (“PLL”), wherein the PLL may generate a signal that is locked to the phase of a reference signal. The PLL may compare the phase of programmable oscillator 120 to the reference, and automatically raise or lower the frequency of the oscillator 120 until its phase is matched to that of the reference, thereby matching the output frequency.

According to the exemplary embodiments of the present invention, the programmable oscillator 120 may be in communication with the imaging sensor 130, and may include a frequency modulation (“FM”) circuit (not shown). The FM circuit may modulate the output signal in order to reduce the EMI on the output signal. For example, the frequency may dither back and forth between two frequencies in order to reduce the spectral contrast of the peak energy of the output signal. This technique may reshape the EMI emissions from the system 100. Specifically, the modulation of the output signal allows the EMI on the output signal to be spread, or smeared, over a larger frequency spectrum. In other words, the peak energy is smeared between the start and the stop as the frequency dithers. Accordingly, the total amount of energy is still present, however the spreading of the output signal over the frequency band results in a reduction of EMI emissions at any one frequency. Thus, since regulatory bodies such as the FCC place maximum limits for peak EMI emission at any one frequency within the spectrum, the programmable oscillator 120 may be implemented within an electronic device to reduce high EMI peak emissions. As the frequency band gets wider, the peak energy is lowered, thereby allowing the device to be compliant with the EMI requirements of the FCC or any other regulatory body.

As described above, the ASIC chip 140 may process the I/O signals received from the imaging sensor 130. Various embodiments of the present invention will be described with reference to an ASIC chip 140 designed for performing customized (or “semi-customized”) applications within an imaging device. It should be noted that the ASIC chip 140 designed for semi-customized application may be made from field programmable gate arrays, wherein only the top layer, or layers, of metal interconnects defines the circuit function. Alternatively, the ASIC chip 140 may perform fully customized applications, wherein all layers are defined to achieve the circuit function. Those skilled in the art will understand that the present invention may be implanted on any type of computer system including an electronic circuit, wherein the circuit is capable of integrating multiple functions and/or logic control blocks designed to fulfill a specific task in the computer system.

The ASIC chip 140 may include input pins for receiving the SPI from the controller 110 and for receiving data from the imaging sensor 130. Specifically, the SPI may be used for programming the ASIC chip 140 from the controller 110. Furthermore, the data received by ASIC chip 140 from the imaging sensor 130 may include various types of data such as, pixel clock data (“Pixclk”), image data (“Data”), horizontal synchronization (“Hsync”) data, and vertical synchronization (“Vsync”) data. A pixel clock (not shown) may be a high-frequency square wave generated by the PLL of the programmable oscillator 120, wherein the pixel clock generates a display signal's image data, Hsync data, and Vsync data. As described above, the PLL may use a reference signal to generate the pixel clock, wherein the reference signal may be the programmable oscillator 120. Furthermore, the pixel clock may be used to determine when lines of image data include valid data. The pixel clock according to the exemplary embodiments of the present invention may be included within the imaging sensor 130. Alternatively, the pixel clock may be a separate component within the system 100.

In addition, the ASIC chip 140 may include output pins that transmit data to the flex circuit connector 150. According to the exemplary systems and methods of the present invention, the output pins from the ASIC chip 140 may have programmable slew rate controls. The slew rate may be defined as the time rate of change of an output signal from the ASIC chip 140 for all possible input signals received at any point on the ASIC chip 140. In general, the output signal is driving a capacitance load. Thus, by limiting the time rate of change of the output voltage, the EMI emissions would be reduced. The ASIC chip 140 may include programmable parameters such as, programmable current sources and/or programmable output resistances for controlling the slew rate. Specifically, changes applied to the magnitude of the current of the output drive, and/or by changing the output resistance of the output drive, the ASIC chip 140 may control the slew rate. These adjustments made to the slew rate may allow the ASIC chip 140 to limit the amount of current of the drive output to a predetermined value. In addition, the ASIC chip 140 may also include programmable delays. Specifically, the ASIC chip 140 may delay each of the I/O signals independently such that only one signal will transition at a time to the flex circuit connector 150. Accordingly, the delay values at the ASIC chip 140 may be suitably programmed by the controller 110. Because each of the current sources, output resistances and delay values are programmable, the adjustments to the output signals may be adaptive. For example, different users may adjust the output signals in different manners depending on the type of control that the user is attempting to accomplish. In another example, the output signal control may be modified during operation to account for changing operating conditions and/or operating scenarios.

It should be noted that the voltage output high (“VOH”) at each of the outputs of the ASIC 140 may also be programmable. The VOH may be defined as the maximum positive voltage from one of the outputs that the ASIC chip 140 considers will be accepted as the minimum positive high level. According to the exemplary embodiments of the present invention, the ASIC chip 140 may intentionally lower the voltage (e.g., VOH) to be less that the voltage of a power supply. For example, the ASIC chip 140 may be programmed to drive or receive a VOH of 1.8V. The adjustment made in the voltage may transition the voltage domain from a low state to a high state.

FIG. 1B shows an output component 145 (e.g., one of the output pins) of the exemplary ASIC chip 140 for programming the slew rate from the ASIC chip 140 according to the exemplary embodiments of the present invention. The output component 145 of the ASIC chip 140 may be in communication with the flex circuit connector 150. As described above, the ASIC chip 140 may include a plurality of output pins, thus, the output component 145 illustrated in FIG. 1B may be used to describe any of the outputs from the ASIC chip 140. Furthermore, the ASIC chip 140 may include an ASIC core 142 that receives input from the sensor 130. As illustrated in FIG. 1B, the output component 145 may be in communication with the ASIC core 142. Specifically, the ASIC core 142 may transmit programmed input/output parameters to the output component 145. The programmed parameters may drive a load capacitance on the host side via the flex circuit connector 150.

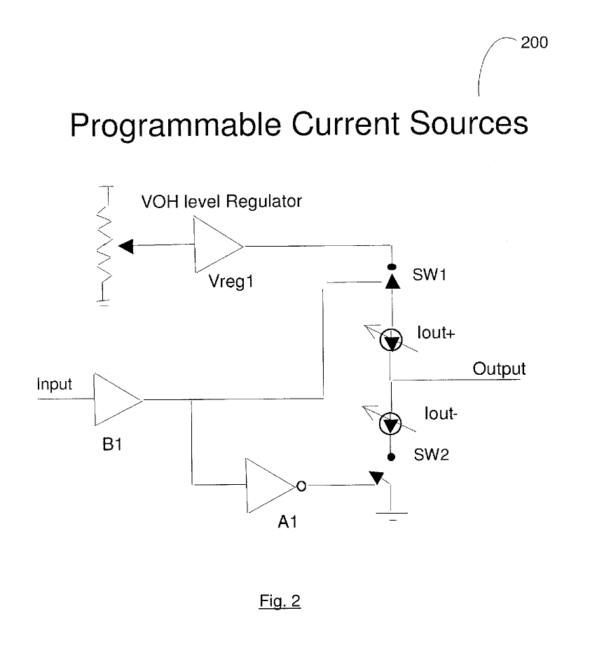

The programmable parameters may include a delay value 143 that allows the ASIC chip 140 to delay the output signal from the output component 145. The delay value 143 may be programmed to a suitable value such that only one signal will transition from the ASIC chip 140 at a time to the flex circuit connector 150. Accordingly, by limiting the number of signals transitioning from the ASIC chip 140 at any given time, the exemplary embodiments of the present invention may reduce the EMI emissions radiated from the imaging sensor 130 as image data is transmitted to the flex circuit connector 150. The programmable delay value 143 will be described in greater detail in relation to FIG. 2.

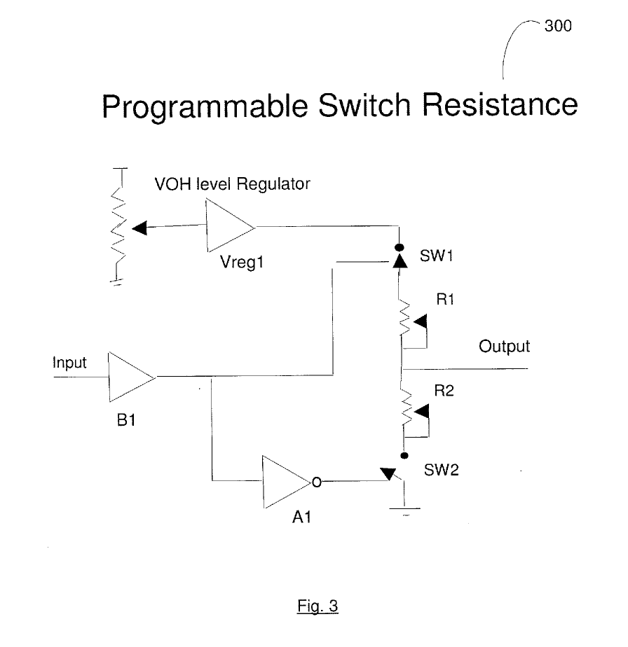

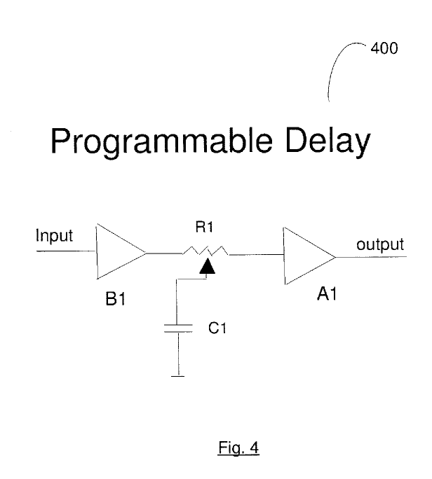

The programmable parameter may alternatively, or additionally, include programmable current sources and/or outputs having programmable resistances 144. Specifically, changing any of these parameters may create adjustments to the slew rate of the output. For example, the programmable current sources may allow for a transition from a low state to a high state, changing (e.g., limiting) the current of the output drive, stumping a known current, etc. In addition, the programmable resistors may also serve as a slew rate controlling technique. The programmable current sources and output resistances 144 will be described in greater detail in relation to FIG. 3 and FIG. 4, respectively.

FIG. 2 shows an exemplary schematic 200 for a programmable current source within the exemplary ASIC chip 140 according to the exemplary embodiments of the present invention. Similar to the output component 145 described in FIG. 1B, the schematic 200 illustrated in FIG. 2 may be used to describe any of the outputs from the ASIC chip 140, wherein the magnitude of the output current is programmed by the controller 110. Specifically, the values of the output current I(out+) at switch SW1 and the output current I(out−) at switch SW2 may allow for the adjustments to be made in the slew rate, thereby creating a programmable slew rate control at one or more of the output pins of the ASIC chip 140. As described above, the adjustments made to the slew rate may allow the ASIC chip 140 to limit the amount of current of the drive output and the time rate of change of the output voltage, thereby reducing EMI emissions for the output signal.

FIG. 3 shows an exemplary schematic 300 for a programmable output resistance within the exemplary ASIC chip 140 according to the exemplary embodiments of the present invention. Similar to the output component 145 described in FIG. 1B, the schematic 300 illustrated in FIG. 3 may be used to describe any of the outputs from the ASIC chip 140, wherein the magnitude of the output resistance is programmed by the controller 110. Specifically, altering the values of the output resistance R1 at switch SW1 and the output resistance R2 at switch SW2 may allow for the adjustments to be made in the slew rate, thereby creating a programmable slew rate control at one or more of the output pins of the ASIC chip 140. As described above, the adjustments made to the slew rate may allow the ASIC chip 140 to limit the amount of current of the drive output and the time rate of change of the output voltage, thereby limiting the EMI emissions.

FIG. 4 shows an exemplary schematic 400 for a programmable delay within the exemplary ASIC chip 140 according to the exemplary embodiments of the present invention. Similar to the output component 145 described in FIG. 1B, the schematic 400 illustrated in FIG. 4 may be used to describe any of the outputs from the ASIC chip 140, wherein the magnitude of the delay value of the output signal is programmed by the controller 110. Specifically, the ASIC chip 140 may include a resistor R1 for delaying the I/O signals (independent from other I/O signals of the ASIC chip 140) such that only one signal will transition at time from the ASIC chip 140 to the flex circuit connector 150. Accordingly, the delay values at the ASIC chip 140 may be suitably programmed by the controller 110.

Those skilled in the art will understand that the circuits presented in FIGS. 2-4 are only exemplary and that there are other types of circuits may also accomplish the functions of the circuits, e.g., current control, resistance control and/or time delay control, in order to control the slew rate of the imaging signal. In addition, as noted above, an exemplary ASIC may implement one or more of the described control types in order to produce the desire output for the imaging signal.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. An electronic device, comprising:
an imaging sensor collecting an image and creating an imaging signal corresponding to the image;
an integrated circuit receiving the imaging signal from the imaging sensor and modifying a transfer characteristic of the imaging signal; and
a connector receiving the imaging signal from the integrated circuit having the modified transfer characteristic.

2. The electronic device of claim 1, wherein the imaging signal includes one of pixel clock data, image data, horizontal synchronization data and vertical synchronization data.

3. The electronic device of claim 1, wherein the transfer characteristic is a slew rate of the imaging signal.

4. The electronic device of claim 3, wherein the integrated circuit includes a programmable current source to modify the slew rate.

5. The electronic device of claim 3, wherein the integrated circuit includes a programmable output resistance to modify the slew rate.

6. The electronic device of claim 1, wherein the integrated circuit includes a programmable delay.

7. The electronic device of claim 1, wherein the integrated circuit is one of an application specific integrated circuit and a field programmable gate array circuit.

8. The electronic device of claim 1, wherein the integrated circuit includes a plurality of outputs, each output including a programmable voltage output high.

9. The electronic device of claim 1, further comprising:
a controller to provide instructions to the integrated circuit, wherein the integrated circuit includes a serial interface for receiving the instructions.

10. The electronic device of claim 1, wherein the connector is a parallel flexible circuit connector.

11. The electronic device of claim 1, further comprising:
a programmable oscillator providing a timing signal to the imaging sensor.

12. A method, comprising:
receiving an imaging signal;
modifying a transfer characteristic of the imaging signal, the modification of the transfer characteristic reducing EMI emissions of the imaging signal; and
outputting the imaging signal with the modified transfer characteristic.

13. The method of claim 12, wherein the transfer characteristic is a slew rate of the imaging signal.

14. The method of claim 13, wherein the modifying the slew rate of the imaging signals includes one of altering a magnitude of the output current of the imaging signal, increasing an output resistance through which the imaging signal passes and introducing a delay in the output of the imaging signal.

15. The method of claim 12, wherein the imaging signal includes one of pixel clock data, image data, horizontal synchronization data and vertical synchronization data.

16. The method of claim 12, further comprising:
receiving program instructions identifying the modification to the transfer characteristic that is to be performed.

17. The method of claim 12, wherein the transfer characteristic is adaptively modified.

18. A circuit, comprising:
an input receiving a signal;
a core performing at least one operation on the signal; and
an output modifying a transfer characteristic of the signal and outputting the signal having the modified transfer characteristic.

19. The circuit of claim 18, wherein the output includes a programmable current source to modify the transfer characteristic.

20. The circuit of claim 18, wherein the output includes a programmable output resistance to modify the transfer characteristic.

21. The circuit of claim 18, wherein the output includes a programmable delay element to modify the transfer characteristic.

22. The circuit of claim 18, wherein the transfer characteristic is a slew rate.

23. An electronic device, comprising:
a first means for collecting an image and creating an imaging signal corresponding to the image;
a second means for receiving the imaging signal from the first means and modifying a transfer characteristic of the imaging signal; and
a third means for receiving the imaging signal from the second means having the modified transfer characteristic.
